(19) United States
(12) Patent Application Publication
(10) Pub. No.: US 2018/0232213 A1
(43) Pub. Date: Aug. 16, 2018

(54) CUSTOMIZED INTERACTION MANIPULATION AND IMPLEMENTATION FOR RESOURCE STORAGE

(71) Applicant: Bank of America Corporation, Charlotte, NC (US)

(72) Inventors: Tracy Beth Greene, Mooresville, NC (US); Emily Paige Bosin, Charlotte, NC (US); Sean Michael Gutman, Waxhaw, NC (US)

(21) Appl. No.: 15/430,000

(22) Filed: Feb. 10, 2017

(51) Int. Cl. G06F 9/44; G06F 9/445; G06Q 40/02

(52) U.S. Cl. CPC G06F 8/34; G06Q 40/02; G06F 8/61

(57) ABSTRACT

Embodiments of the invention are directed to a system, method, or computer program product for interaction manipulation for implementing resource storage. The system receives interaction information associated with a user which includes past interactions as well as a resource storage target. Based on the received past interactions, the system determines one or more recommended interactions which would assist the user in achieving the resource storage target. The system generates and installs an interactive user application on a user device associated with the user, before generating interactive tokens based on the past and recommended interactions. The system prompts the user to manipulate the generated tokens within the application to allow for the generation and implementation of a revised interaction program. Furthermore, the system may automatically modify user interactions by cancelling past interactions not included in the revised interaction program while enrolling the user in the newly included recommended interactions.

### BACKGROUND

While methods of interaction management and implementation are currently available, there exists a need for an intuitive, holistic approach for managing and implementing revised interaction programs by allowing for the manipulation of interactions extracted from multiple systems in a central location while additionally allowing for the creation of customized interaction programs.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing an innovative system, method, and computer program product for interaction manipulation and implementation for resource storage, the system comprising: at least one memory device with computer-readable program code stored thereon; at least one communication device connected to a network; at least one processing device operatively coupled to the at least one memory device and the at least one communication device, wherein the processing device is configured to execute the computer-readable program code to: receive interaction information associated with a user, wherein the interaction information comprises past interactions and a resource storage target; in response to receiving the past interactions, determine recommended interactions based on the past interactions; generate an interactive user application, wherein the interactive user application is customized based on the interaction information and the recommended interactions; install the interactive user application on a user device associated with the user; generate interactive tokens based on the past interactions and the recommended interactions; prompt the user to manipulate the interactive tokens thereby generating a revised interaction program; and implement the revised interaction program.

In some embodiments of the invention, implementing the revised interaction program comprises automatically modifying user interactions.

In some embodiments, modifying the user interactions comprises canceling at least one past interaction.

In some embodiments, modifying the user interactions comprises enrolling the user in at least one recommended interaction.

In some embodiments, implementing the revised interaction program further comprises: determining that the revised interaction program does not achieve the resource storage target; and based on determining that the revised interaction program does not achieve the resource storage target, blocking implementation of the revised interaction program.

In some embodiments, implementing the revised interaction program further comprises: generating and presenting a request for a confirmation of the revised interaction program to the user; receiving the confirmation of the revised interaction program from the user; and based on receiving the confirmation, implementing the revised interaction program.

In some embodiments, manipulating the interactive tokens further comprises making a selection of the interactive tokens for inclusion in the revised interaction program.

In some embodiments, a total value associated with the past interactions and the recommended interactions associated with selected interactive tokens achieves the resource storage target.

In some embodiments, the interactive tokens proportionally represent values of the past interactions and the recommended interactions associated with the interactive tokens.

In some embodiments, the past interactions comprise transactions and subscriptions associated with the user.

In some embodiments, the recommended interactions comprise transactions and subscriptions not associated with the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides an electronic resource manipulation and distribution system environment, in accordance with one embodiment of the present invention;

FIG. 2 provides a high level process flow for manipulating and implementing customized interactions for resource storage, in accordance with one embodiment of the present invention;

FIG. 3 provides a high level process flow for evaluating and blocking a revised interaction program, in accordance with one embodiment of the present invention;

FIG. 4 provides illustrates a high level process flow for implementing a revised interaction program based on user confirmation, in accordance with one embodiment of the present invention; and

FIG. 5 provides a graphical representation of a portion of an interactive user application, in accordance with one embodiment of the present invention.

### DETAILED DESCRIPTION OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

A “user” as used herein may refer to any entity or individual associated with the interaction manipulation and resource storage implementation system. In some embodiments, a user may be a mobile device application user and/or a financial institution customer (e.g., an account holder or a person who has an account (e.g., banking account, credit account, or the like)). In some embodiments, identities of an individual may include online handles, usernames, aliases, family names, maiden names, nicknames, or the like. Furthermore, as used herein the term “user device” may refer to any device that employs a processor and memory and can perform computing functions, such as a personal computer or a mobile device, wherein a mobile device is any mobile communication device, such as a cellular telecommunications device (i.e., a cell phone or mobile phone), personal digital assistant (PDA), a mobile Internet accessing device, or other mobile device. Other types of mobile devices may include portable digital assistants (PDAs), pagers, wearable devices, mobile televisions, gaming devices, laptop computers, cameras, video recorders, audio/video player, radio, global positioning system (GPS) devices, or any combination of the aforementioned.

In accordance with embodiments of the invention, the terms “financial institution” and “financial entity” may be used to include any organization that processes financial transactions including, but not limited to, banks, credit unions, savings and loan associations, investment companies, stock brokerages, assess management firms, insurance companies and the like. In specific embodiments of the invention, use of the term “bank” is limited to a financial entity in which account-bearing customers conduct financial transactions, such as account deposits, withdrawals, transfers and the like. In other embodiments, an entity may be a business, organization, or the like that is not a financial institution.

An “account” is the relationship that a user has with an entity, such as a financial institution or bank. Examples of accounts include a deposit account, such as a transactional account (e.g., a banking account), a savings account, an investment account, a money market account, a time deposit, a demand deposit, a pre-paid account, a credit account, a non-monetary user profile that includes information associated with the user, or the like. The account is associated with and/or maintained by the entity. In some embodiments, the account is maintained by a third-party entity or financial institution. “Resources” may be funds or assets that include accounts of the user and/or other property owned by the user. The assets may be associated with accounts or may be property that is not associated with a specific account. Examples of assets associated with accounts may be accounts that have cash or cash equivalents, or accounts that are funded with or contain property, such as safety despots box account that jewelry, a trust account that is funded with property, or the like. Examples of assets that may not be associated with accounts may be antiques in a user's home, jewelry in a user's home, or the like. In some embodiments, “electronic resources” may refer to financial assets, funds, and/or resources that are maintained and stored in an electronic form on computer systems or devices. For example, electronic resources may include funds stored in an online banking account maintained by a financial institution. In some embodiments, electronic funds may also refer to other digital currencies and cryptocurrencies which may be stored on a user device or maintained in an account by a third party. In some embodiments, resources may further comprise coupons, offers, rebates, or discounts that are available to the user.

“Authentication information” is any information that can be used to identify of a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to authenticate the identity of the user (e.g., determine that the authentication information is associated with the account) and determine that the user has authority to access an account or system.

To “monitor” is to watch, observe, or check something for a special purpose over a period of time. The “monitoring” may occur periodically over the period of time, or the monitoring may occur continuously over the period of time. In some embodiments, a system may actively monitor a database, wherein the system reaches out to the database and watches, observes, or checks the database for changes, updates, and the like. In other embodiments, a system may passively monitor a database, wherein the database provides information to the system and the system then watches, observes, or checks the provided information. A “transaction” or “interaction” refers to any communication between one or more users, one or more financial institutions, and/or other entities monitoring the user's activities. For example, a transaction may refer to a purchase of goods or services, a return of goods or services, a payment transaction, a credit transaction, or other interaction involving a user's account. In some embodiments, an interaction may further comprise an offer, quote, or estimate provided by an entity, third party, other user, or the like to the user for consideration.

Embodiments of the invention are directed to a system, method, or computer program product for interaction manipulation for implementing resource storage. The system receives interaction information associated with a user which includes past interactions as well as a resource storage target which acts as a goal for any implemented interaction program. Based on the received past interactions, the system determines one or more recommended interactions which would assist the user in achieving the resource storage target. The system generates and installs an interactive user application on a user device associated with the user, before generating interactive tokens based on the past and recommended interactions. The system prompts the user to manipulate the generated tokens within the application to allow for the generation and implementation of a revised interaction program. Furthermore, the system may automatically modify user interactions by cancelling past interactions not included in the revised interaction program while enrolling the user in the newly included recommended interactions.

While methods of manipulating and managing resources and interactions exist, it can be difficult for a user to receive a holistic view of all available potential interactions and offers simultaneously as potentially resource-saving interactions can be offered by different entities across several systems or virtual locations. Furthermore, being in communication with several systems simultaneously expends computer resources of a user device such as computer processing power, available memory, and network bandwidth. The present invention solves this technical problem which arises manipulating and managing resources and interactions in an online environment with a computing device by providing a collected repository of recommended interactions and offers to the user from a single source so that a user device does not need to maintain connections with several additional systems. Additionally, by determining recommended interactions and generating a customized interactive application for the user, the system effectively filters unnecessary information and selectively provides only the recommended interactions that would be of interest to the user based on the user's interaction information. First, determining recommended interactions further reduces the amount of information and data that would normally need to be transmitted to the user device and, therefore, increases the efficiency of the push of potential interaction data to the user device.

Embodiments of the present invention address the above needs and/or achieve other advantages by providing apparatuses (e.g., a system, computer program product and/or other devices) and methods for interaction manipulation for implementing resource storage.

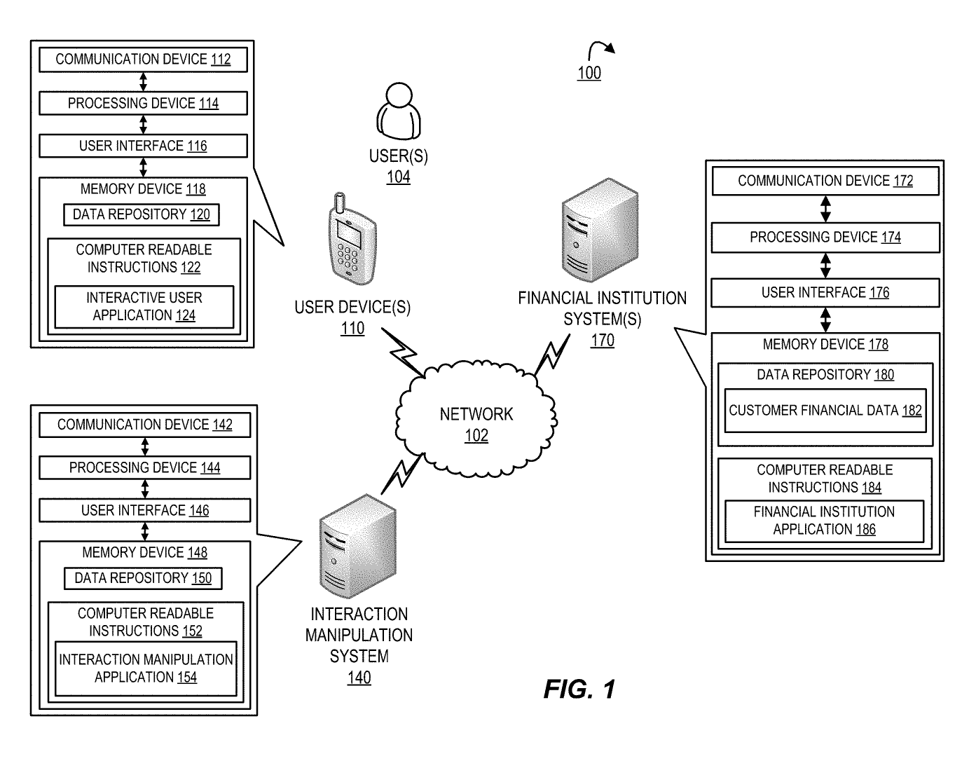

Referring to FIG. 1, the figure illustrates an electronic resource manipulation and distribution system environment 100, in accordance with some embodiments of the invention. The environment 100 includes a user device 110 associated or used with authorization of a user 104 (e.g., a mobile application user, and the like), a interaction manipulation system 140, and a financial institution system 170.

As used herein, a “processing device,” such as the processing devices 114, 144, and 174 generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” such as the user interfaces 116, 146, and 176 generally includes a plurality of interface devices and/or software that allow a customer to input commands and data to direct the processing device to execute instructions. For example, the user interfaces presented in FIG. 1 may include a graphical user interface (GUI) or an interface to input computer-executable instructions that direct the processing device to carry out specific functions. The user interface employs certain input and output devices to input data received from a user or output data to a user. These input and output devices may include a display, mouse, keyboard, button, touchpad, touch screen, microphone, speaker, LED, light, joystick, switch, buzzer, bell, and/or other customer input/output device for communicating with one or more customers.

As used herein, a “memory device” such as memory devices 118, 148, and 178 generally refers to a device or combination of devices that store one or more forms of computer-readable media for storing data and/or computer-executable program code/instructions. Computer-readable media is defined in greater detail below. For example, in one embodiment, the memory device includes any computer memory that provides an actual or virtual space to temporarily or permanently store data and/or commands provided to the processing device when it carries out its functions described herein.

As used herein, a “communication interface” generally includes a modem, server, transceiver, and/or other device for communicating with other devices on a network, and/or a user interface for communicating with one or more customers. Referring again to FIG. 1, the communication devices 112, 142, and 172 are communication interfaces having one or more devices configured to communicate with one or more other devices on a network, such as a mobile device, a personal computing device, a mobile banking system, other financial institution banking systems, third party systems, and/or the like. The processing device is configured to use the network communication device to transmit and/or receive data and/or commands to and/or from the other devices connected to the network.

The systems and devices communicate with one another over the network 102 and perform one or more of the various steps and/or methods according to embodiments of the disclosure discussed herein. The network 102 may include a local area network (LAN), a wide area network (WAN), and/or a global area network (GAN). The network 102 may provide for wireline, wireless, or a combination of wireline and wireless communication between devices in the network. In one embodiment, the network 102 includes the Internet.

The user device 110 includes a communication device 112 communicably coupled with a processing device 114, which is also communicably coupled with a memory device 118. In some embodiments, the communication device 112 may also comprise a GPS transceiver capable of determining a geographic location associated with the user device 110. The processing device 114 is configured to control the communication device 112 such that the user device 110 communicates across the network 102 with one or more other systems. The processing device 114 is also configured to access the memory device 118 in order to read the computer readable instructions 122, which in some embodiments includes an interactive user application 124. The interactive user application 124 allows for communication of the user device 110 with the other systems and devices within the environment 100 such as the interaction manipulation system 140, and financial institution system 170. The interactive=user application 124 allows the user 104 to receive information transmitted as well as input information requested by the other systems and communicate with a financial institution, one or more third parties, and/or other entities. In some embodiments, the interactive user application 124 further allows the user to manipulate interactive tokens in order to generate an interaction program. The memory device 118 also includes a data repository 120 or database for storing pieces of data that can be accessed by the processing device 114.

The interaction manipulation system 140 includes a communication device 142 communicably coupled with a processing device 144, which is also communicably coupled with a memory device 148. The processing device 144 is configured to control the communication device 142 such that the interaction manipulation system 140 communicates across the network 102 with one or more other systems. The processing device 144 is also configured to access the memory device 148 in order to read the computer readable instructions 152, which in some embodiments includes a interaction manipulation application 154. The interaction manipulation application 154 allows for communication with the other systems and devices within the environment 100 such as the user device 110 and the financial institution system 170. The memory device 148 also includes a data repository 150 or database for storing pieces of data that can be accessed by the processing device 144. In some embodiments, the data repository 150 further comprises a repository of recommended interactions extracted from one or more systems associated with other entities such as third party systems (not shown). In some embodiments, the interaction manipulation system 140 may be part of the financial institution systems 170 or the user device 110.

As illustrated in FIG. 1, in one embodiment of the invention, the financial institution system 170 includes a processing device 174 operatively coupled to a network communication device 172 and a memory device 178. The financial institution system 170 includes a communication device 172 communicably coupled with a processing device 174, which is also communicably coupled with a memory device 178. The processing device 174 is configured to control the communication device 172 such that the financial institution system 170 communicates across the network 102 with one or more other systems. The processing device 174 is also configured to access the memory device 178 in order to read the computer readable instructions 184, which in some embodiments includes a financial institution application 186. The financial institution application 186 allows for communication with the other systems and devices within the environment 100 such as the user device 110 and the interaction manipulation system 140. The memory device 178 also includes a data repository 180 or database for storing pieces of data that can be accessed by the processing device 174.

The interactive user application 124, the interaction manipulation application 154, and the financial institution application 186 are for instructing the processing devices on their respective systems to perform various steps of the methods discussed herein, and/or other steps and/or similar steps. In various embodiments, one or more of the various applications discussed are included in the computer readable instructions stored in a memory device of one or more systems or devices other than their respective systems and/or devices. For example, in some embodiments, the interaction manipulation application 154 is stored and configured for being accessed by a processing device of the financial institution system 170 connected to the network 102. In various embodiments, the interactive user application 124, the interaction manipulation application 154, and the financial institution application 186 are stored and executed by different systems/devices. In some embodiments, the discussed applications may be similar and may be configured to communicate with one another. In some embodiments, the various applications may be considered to be working together as a singular application despite being stored and executed on different systems.

In various embodiments, one of the systems discussed above, such as the financial institution system 170, is more than one system and the various components of the system are not collocated, and in various embodiments, there are multiple components performing the functions indicated herein as a single device. For example, in one embodiment, multiple processing devices perform the functions of the processing device 174 of the financial institution system 170 described herein.

In various embodiments, the user device 110, the interaction manipulation system 140, the financial institution system 170, and/or other systems may perform all or part of a one or more method or process steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of one or more of the method discussed herein, or other methods, processes or steps discussed herein or not discussed herein.

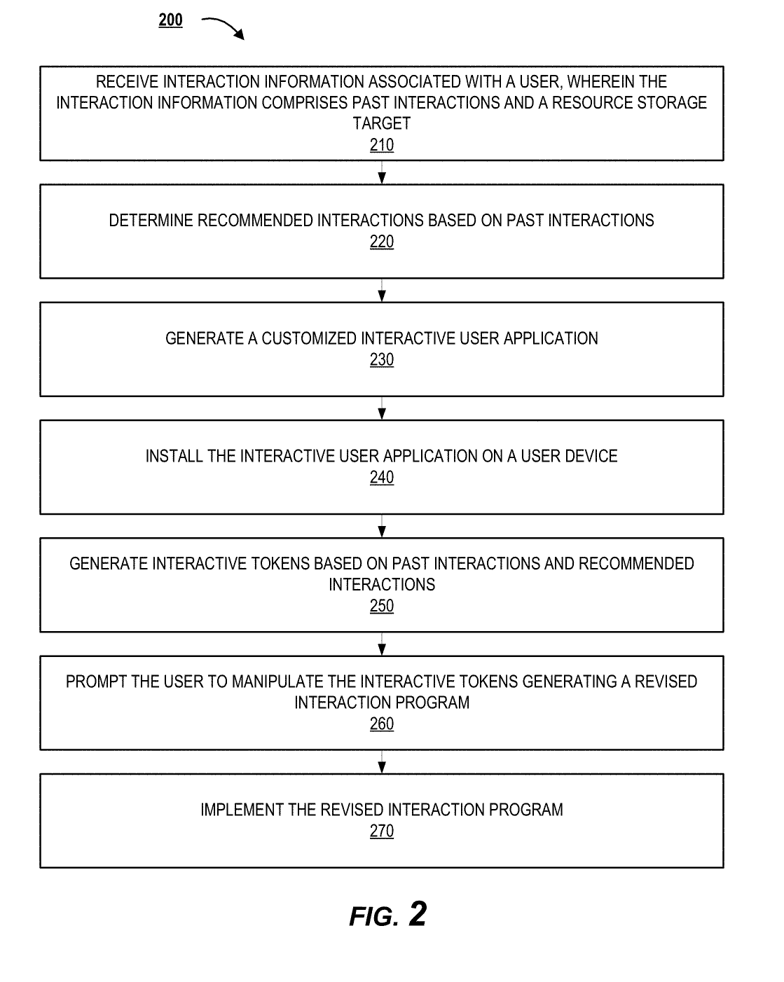

FIG. 2 illustrates a high level process flow for manipulating and implementing customized interactions for resource storage 200, in accordance with one embodiment of the invention. As illustrated in block 210, the process 200 is initiated by first receiving interaction information associated with a user. Interaction information comprises financial or banking information associated with a user. In some embodiments, the system extracts interaction information associated with the user form one or more financial accounts such as a checking account, savings account, or the like. In some embodiments, the system and the interaction information associated with the user are maintained by the same entity, such as a financial institution or bank. In other embodiments, the system and interaction information associated with the user are maintained separately, by different entities or by one or more third parties. In some embodiments, the interaction information extracted by the system further comprises user-identifying, personal information, such as name, address, phone number, e-mail address, usernames, passwords, and other account information.

The interaction information may include a transactional history associated with a user, wherein the user's past interactions or transactions are included in the interaction information. Furthermore, interaction information may also include scheduled one-time and recurring payments such as automated bill payments, subscriptions, or the like. In some embodiments, the interaction information further comprises a resource storage target. As used herein, a resource storage target refers to a financial savings goal set by a user or a financial institution associated with the user. In some embodiments, the resource storage target is a monetary amount that the user wishes to save or store over a period of time. For example, a user may wish to save a certain amount of money in the coming year by December. In some embodiments of the invention, the resource storage target may be a recurring goal. For example, a user may wish to save $500 every month. In some embodiments, the resource storage target may be a budget or allowance, wherein the user may not wish to spend over a predetermined threshold amount over a period of time. For example, a user may set a monthly spending budget, wherein achieving the monthly spending budget involves spending, at most, the budgeted monthly amount in a particular month.

In some embodiments, the interaction information may further comprise geolocation information associated with a user device associated with the user. The system may receive or extract geolocation information from a user device associated with the user. In some embodiments of the invention, the system may use the received geolocation information associated with the user device to further develop a profile of the user's transactional history and habits. For example, the system may extract from the geolocation information associated with the user device in combination with the user's past interactions that the user regularly makes purchases at a particular business, such as a particular grocery store or coffee shop. The system may further employ geolocation information to determine underutilized interactions or recurring transactions by determining that the user is not frequently located near a location, such as a business, associated with the underutilized interaction. For example, the system may determine that the user has a monthly gym membership from the user's transactional history, however the system also determines that the user has infrequently used the membership based on the user device associated with the user having not been located at the gym over the past month.

As illustrated in block 220 of FIG. 2, the system determines one or more recommended interactions based on the past interactions. The one or more recommended interactions are transactions for products or services that are comparable to those associated with the user's past interactions or may replace one or more of the user's past interactions. In some embodiments the recommended interactions are new interactions that are not comparable to the user's past interactions. In some embodiments, a recommended interaction may have a lower cost than a comparable past transaction. By recommending to replace a past interaction with a new, recommended interaction, the system may assist the user in reducing financial costs to achieve a resource storage target. For example, based on identifying from past transactions that a user is paying a certain monthly amount for internet service from a first internet provider, the system may recommend that the user replace the interaction and instead receive internet service from a second internet provider who offers a comparable service for a lower monthly cost.

In some embodiments, the system further determines the one or more recommended interactions based on the geolocation information associated with the user device associated with the user. Determining that the user device associated with the user is located at a particular location, such as a particular store or business, may trigger the system to generate a recommended interaction associated with that particular store or business. For example, the system may use the geolocation information to determine that the user regularly shops at grocery store A and recommend that the user instead shop at grocery store B which is less expensive on average.

In some embodiments of the invention, the recommended interactions further comprise offers such as coupons, discounts, rebates, and the like which can supplement an interaction program associated with a user in order to reduce financial costs and assist in achieving the resource storage target. The system may determine particular products or services regularly purchased by the user from the past interaction associated with the user. In some embodiments, the system prompts the user to categorize past interactions and provide additional details associated with specific purchases such as item level product or service identification, SKUs, barcodes, receipt information, or the like. For example, the system may determine that the user has purchased or regularly purchases a product and provide the user with a coupon for the product to reduce the user's expenditures.

In some embodiments, the system accesses a database of recommended interactions stored within the memory of the system to extract recommended interactions to the user. In some embodiments, the system may recommend interactions associated with businesses or entities affiliated with an entity maintaining the system. For example, a bank maintaining the invention may recommend interactions associated with businesses, partners, clients, or the like affiliated with the bank. In some embodiments, the system may provide recommended interactions associated with outside or third party entities. The system may establish operative communication channels to third party systems in order to extract information related to recommended interactions from the third party systems. In some embodiments, the system generates a repository of recommended interactions extracted from one or more third parties and other entities and stores them within the memory of the system. In this way, the system may provide the user with a single, comprehensive source of recommended interactions so that the user does not have to access additional systems to receive a holistic view of all available interactions. Additionally, in some embodiments, the system presents the user with the determined recommended interactions which reduces the amount of unnecessary information and data transmitted from the system to the user device. In this way, the system effectively filters potential interactions and presents a customized set of recommended interactions to the user.

As illustrated in block 230 of FIG. 2, the system generates a customized interactive user application. By generating a customized interactive user application, the system provides the user with a centralized, interactive workspace for easily and intuitively manipulating multiple interactions or offers collected from multiple sources. In some embodiments, the generated interactive user application is customized according to the user's extracted interaction information, wherein the application is tailored for the user based on the user's past interactions, resource storage target, and recommended interactions. In some embodiments, the system may generate a new, interactive user application in response to an updated resource storage target, wherein the system automatically removes the previously installed application from the user device and replaces it with the new application. In other embodiments, the system may modify a preexisting interactive user application by updating a previously generated interactive user application installed on a user device instead of removing and installing a new application. In some embodiments, the interactive user application may be updated in real-time based on the interaction information associated with the user and recommended interactions, so that the user is always presented with the most current information.

In some embodiments of the invention, the interactive user application may allow the user and/or system to manipulate application-generated objects to create a revised interaction program. In some embodiments, the system, via the application, may present the user with the resource storage target and the one or more of the past interactions and recommended interactions. In some embodiments, the application may present the user with a total cost and/or savings of currently selected interactions. In some embodiments, the application may further present the total cost and/or savings of selected interactions in relation to a resource storage target. For example, the application may present a total cost and/or savings of current interactions associated with the user and display the total cost and/or savings of the selected interactions as being higher than, lower than, or meeting a budget associated with the user. In some embodiments, the resource storage target may be displayed in the interactive application as text, an image, a line, a shape, a graph, a chart, a threshold, a puzzle, a progress bar, a fillable container, or any object which represents the value of the resource storage target and/or progress towards the resource storage target. In some embodiments of the invention, the application may further comprise a game, a puzzle, or the like, wherein objects or tokens representing values generated by the application may be manipulated by the user and/or system in order to generate a savings program.

As illustrated in block 240 of FIG. 2, the system installs the interactive user application on a user device. In some embodiments, the system installs the interactive user application in response to a user providing a resource storage target, wherein providing a resource storage target automatically triggers the installation and/or launch of the application on the user device, wherein the system transmits a command signal over the network to instruct the user device to install and/or launch the application. In some embodiments, the interactive user application is a part of an online banking application or mobile banking application installed on a user device. In some embodiments, installing the application comprises the user device accessing a website, digital store, or other system, wherein the application information is transmitted, installed, and stored within the memory of the user device. In some embodiments, the system transmits the application to the user device for installation.

As illustrated in block 250 of FIG. 2, the system generates one or more interactive tokens based on past interactions and the recommended interactions. Interactive tokens generated by the system may be text, images, shapes, computer-generated objects, and the like presented to the user via the interactive user application that represent the one or more past and recommended interactions and may be manipulated by the user and/or system to assist in creating a revised interaction program. In some embodiments, the interactive tokens are generated or engineered to contain information or data related to the interaction associated with the token, such as pricing information, routing information associated with the provider of the interaction, product or service information associated with the interaction, and the like.

In some embodiments of the invention, the interactive tokens may be blocks or shapes which may be arranged by the user to generate a revised interaction program. In some embodiments, the interactive tokens may be scaled proportionally to one another, wherein a characteristic of a token, such as dimension, color, number, or the like, progressively increases or intensifies with its representative value relative to other tokens. For example, the system may generate a first token representing a first interaction with a value of $10 and a second token representing a second interaction with a value of $20, wherein the first generated token is a block of half the length of the second generated token to proportionally signify the values of the two blocks relative to one another. Through the manipulation of the interactive tokens, the system is able to generate a revised interaction program for the user.

In other embodiments, the interactive tokens comprise at least a portion of an image or object displayed on the interactive user application, wherein the interactive tokens may be fit together to complete the image or object. In some embodiments, the interactive tokens may be puzzle pieces, shapes, or the like which may be manipulated or combined to complete an image or object. In some embodiments, completion of the image or object may represent achieving a resource storage target. For example, a user may set a resource storage target of $200 in savings for purchasing a pair of shoes, wherein the interactive tokens comprise puzzle pieces which, upon being manipulated by the user in the interactive application, combine to form an image of a pair of shoes, wherein complete of the image represents a combination of past and recommended interactions that achieves the resource storage target.

In some embodiments, the system may be triggered to generate one or more interactive tokens based the geolocation information associated with the user device. For example, the system may determine from the user's past interactions that the user normally shops at a more expensive grocery store A. Upon the determining from the received geolocation information that the user is located at a less expensive grocery store B, the system triggers the generation of an interactive token for a recommended interaction associated with shopping at the less expensive store.

As illustrated in block 260 of FIG. 2, the system prompts the user to manipulate the interactive tokens and generates a revised interaction program. The revised interaction program comprises the past interactions and the recommended interactions selected by the user in the interactive user application. In some embodiments, the revised interaction program comprises at least one of the recommended interactions determined by the system. In some embodiments, at least one past interaction is replaced by one or more recommended interactions within the revised interaction program to reduce the expenditures of the user.

In some embodiments, the system prompts the user to manipulate the interactive tokens to create the revised interaction program that achieves the resource storage target. In some embodiment, manipulating the interactive tokens comprises arranging the interactive tokens within the interactive user application. In some embodiments, the resource storage target may be used as an approval threshold for a revised interaction program created by manipulating the interactive tokens, wherein the revised interaction program is approved if it achieves the resource storage target. Achieving a resource storage target may include a total value of a revised interaction program being within a set budget, reaching a savings goal, or the like. For example, a monthly spending budget associated with a user may be considered achieved if the user does not spend more than the budgeted amount in the month. In other embodiments of the invention, a revised interaction program may not need to achieve the resource storage target to be approved.

In some embodiments of the invention, the interactive user application is a game, puzzle, or the like for resource storage, wherein the user is prompted to manipulate the interactive tokens displayed on the user device. In one embodiment, the system prompts the user to arrange or stack blocks to fit underneath or reach a threshold, wherein the threshold is the resource storage target. For example, the user stacks blocks proportionally representing transaction values on top of one another while maintaining the height of the stacked blocks beneath a set budget amount. In some embodiments, the system allows for the user to directly and specifically stack the blocks, wherein the stack of blocks may collapse if improperly or unskillfully stacked. By selecting a combination of interactions, as represented by the blocks, with a total value that fits within the budget threshold, the user and system can create a revised interaction program which reduces the user's expenditures and assists in budgeting the user's finances.

In another embodiment of the invention, the system allows the user to manipulate and select past and/or recommended interactions, wherein the values of the selected interactions contribute to a total value which is tracked in comparison to a resource storage target. In some embodiments, contributions and progress towards a resource storage target may be represented as a fillable container. For example, a user may select one or more interactions by dragging and dropping selected interactive tokens representing interactions into a container, wherein the value of each selected interaction is added to the total value of the container, wherein the fill level of the fillable container increases with the total value of the selected interactions thereby tracking progress towards a resource storage target as represented by the capacity of the fillable container.

In yet another embodiment, the system allows the user to manipulate the interactive tokens to complete an image, a shape, a puzzle, a computer-generated object, or the like, wherein the interactive token is a portion or piece of the image, shape, puzzle, object, or the like. In some embodiments, arranging the interactive tokens to complete the object indicates achieving a resource storage target. For example, a user wishing to save resources towards the purchase of a car may be presented with an incomplete image of a car within the interactive user application. Tokens representing various interactions selected by the user for inclusion in a revised interaction program may be displayed as portions of the image of the car. As the user selects money-saving interactions to include in the revised program, the portions of the image car are added to the incomplete image, wherein the image of the car is completed after an amount of resources needed to purchase the car are saved through the selection of the money-saving interactions.

In some embodiments, the system may present via the interactive user application a checklist, roadmap, or other progressive, guided reward structure for achieving a resource storage target, wherein recommended interactions are placed on the checklist, roadmap, or other structure leading to the target. The user progress towards achieving a resource storage target as the user completes recommended interactions placed on the checklist or roadmap generated by the system. In one example, the system may present to a user wishing to save $100 every month a recommendation for purchasing a product, regularly purchased from a first business, from a second business, wherein the price of the product is lower at the second business than at the first business. In a further example, the system may recommend the purchase of a comparable product with a lower price in lieu of a regularly purchased, more expensive product.

In some embodiments, the system calculates a number potential recommended interactions and recommended interaction values necessary for achieving the resource storage target. In some embodiments, the system presents the user with multiple initial recommended interactions, wherein upon the user selecting one or more of the recommended interactions for inclusion in the revised interaction program, the system calculates a second number of potential recommended interactions and recommended interaction values necessary for achieving the resource storage target based on the initial selection by the user. In this way, the system may provide accurate choices to reflect the branching possibilities stemming from the user's selection from multiple initial options as the each of the recommended interactions may possess varying values and contributions to a total interaction amount and resource storage target.

The examples discussed above should not be considered limiting as manipulation of or interaction with the interactive tokens and the interactive user application may comprise any manipulation of the interactive tokens and interactive user application by the user or the system which allows for the selection of one or more past and/or recommended interactions and the comparison of a total value of selected interactions to a resource storage target for generating a revised interaction program.

As illustrated in block 270 of FIG. 2, the system implements the revised interaction program. Generally, the revised interaction program reduces the user's expenditures and assists in achieving the resource storage target. In some embodiments of the invention, implementing the revised interaction program comprises replacing at least one past interaction with at least one recommended interaction. In some embodiments, the system automatically implements the revised interaction program in response to the user manipulating and selecting one or more past and/or recommended interactions. In other embodiments, the system triggers implementation of the revised interaction program in response to the user and/or the system confirming a proposed revised interaction program.

In some embodiments, implementing the revised interaction program may comprise pushing a notification to a user. The system may push a message, notification, or reminder to a user device associated with the user, wherein the message reminds the user of interactions comprising the revised interaction program. In some embodiments, the system pushing notifications to the user may be based on the GPS-determined location of the user device. For example, a user may have chosen to replace a daily purchase of coffee from a first coffee shop location with a daily purchase from a less expensive coffee shop in a revised interaction program generated by the invention. Upon the system determining that the user device associated with the user has entered the first coffee shop location, the system may push a notification the user device reminding the user of the newly accepted, less expensive, recommended interaction contained within the revised interaction program. In some embodiments, pushed notification may be based on pending transactions, wherein the system may push a notification reminding the user of a revised interaction program upon determining that the user is attempting to complete a pending transaction that is not in accordance with the revised interaction program or does not help achieve the resource storage target.

In some embodiments, implementing the revised interaction program further comprises automatically enrolling the user in a recommended interaction, wherein the recommended interaction comprises a subscription, membership, service, utility payment, or other recurring payment. In some embodiments, enrolling the user in the recommended interaction further comprises automatically cancelling a past interaction associated with the user, wherein the past interaction is replaced by the recommended interaction. In some embodiments, the system uses interaction information associated with the user to enroll the user in the new recommended interaction. In some embodiments, the system may establish an operative communication channel with a third party system to enroll and/or cancel user interactions with the third party. For example, in response to the user manipulating the interactive tokens to replace his/her internet service provider A with a less expensive internet service provider B, the system may use the extracted interaction information associated with the user to automatically create an account associated with the user and initiate payment from the user's account to the new internet service provider B. The system may further automatically cancel the past interaction with internet service provider A by transmitting a cancellation request via an operative communication channel or by stopping payment from the user's financial account. In some embodiments, the system may request the user for confirmation via a notification, message, or other transmitted communication before enrolling or cancelling one or more interactions. In some embodiments, the system may provide a link to direct the user to web site to enroll or cancel an interaction instead of automatically enrolling or cancelling the interaction on behalf of the user.

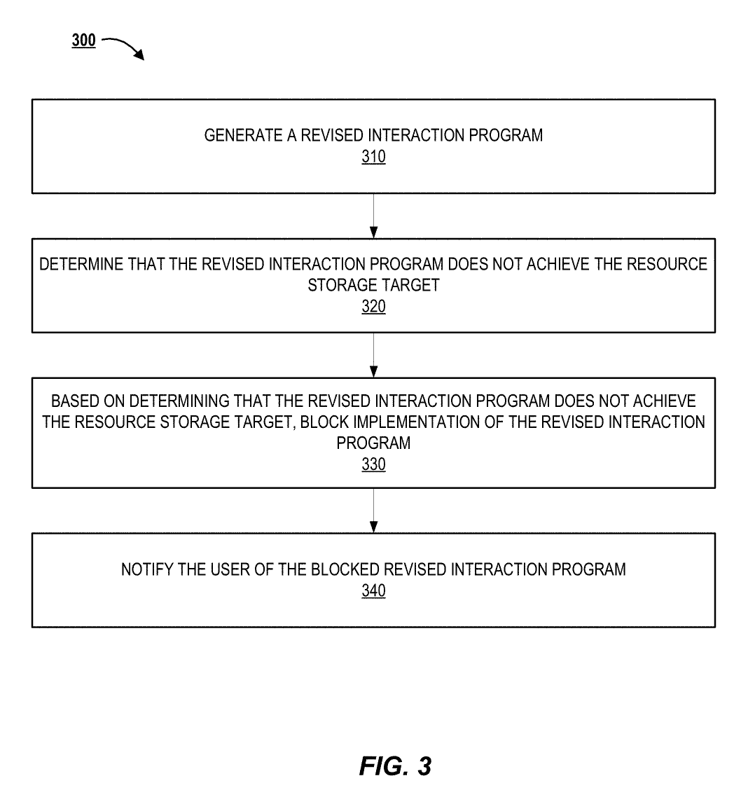

FIG. 3 illustrates a high level process flow for evaluating and blocking a revised interaction program 300, in accordance with one embodiment of the invention. As illustrated in block 310 of FIG. 3, the process 300 is initiated by the system first generating a revised interaction program according to a process similar to that of the process outlined in FIG. 2. As illustrated in block 320 of FIG. 3, the process 300 continues and the system determines that the revised interaction program does not achieve the resource storage target. In some embodiments, the system determines that the revised interaction program does not achieve the resource storage target by comparing the total value of the selected interactions associated with the revised interaction program to that of the resource storage target. In some embodiments, failing to achieve a resource storage target may comprise a total value of the selected interactions associated with the revised interaction program exceeding a set budget, failing to reach a savings goal, or the like.

As illustrated in block 330 of FIG. 3, based on determining that the revised interaction program does not achieve the resource storage target, the system blocks the implementation of the revised interaction program. In this way, the user is prevented from implementing a revised interaction program that does not assist in achieving a resource storage target and increases expenditures. In some embodiments, the system blocks one or more commands for implementation of the revised interaction program transmitted from the user device and/or system to other systems such as financial institution systems or third party systems in response to determining that the resource storage target has not been achieved. Transmitted commands for implementing the revised interaction program may include commands for accepting a revised interaction program, transferring resources as payment, enrolling a user in a new interaction, cancelling an interaction, or the like. In other embodiments, the system may selectively block implementation of only those interactions which do not assist the user in achieving the resource storage target. In this way, the user may still incrementally progress towards a savings goal even if the entirety of the resource storage target is not achieved as a result of a single revised interaction program.

As illustrated in block 340 of FIG. 3, the system notifies the user of the blocked revised interaction program. In some embodiments, the system generates and presents a notification to the user regarding a block revised interaction program. In response to blocking the one or more of the interactions associated with the revised interaction program, the system transmits a notification such as, but not limited to, a message within the interactive user application, a text message, an email, or a voice message. In some embodiments, the notification provides a detailed report of the revised interaction program including associated implemented interactions and blocked interactions to the user. The notification may further provide the user with a reason for blocking interactions associated with the revised interaction program. In some embodiments, the system may generate and display to the user additional recommended interactions which would allow for the previously blocked revised interaction program to achieve the resource storage target, wherein the user may select one or more of the additional recommended interactions for inclusion in the revised interaction program. Upon receiving the user's selection of the additional recommended interactions to modify the revised interaction program to achieve the resource storage target, the system may then automatically implement the revised interaction program.

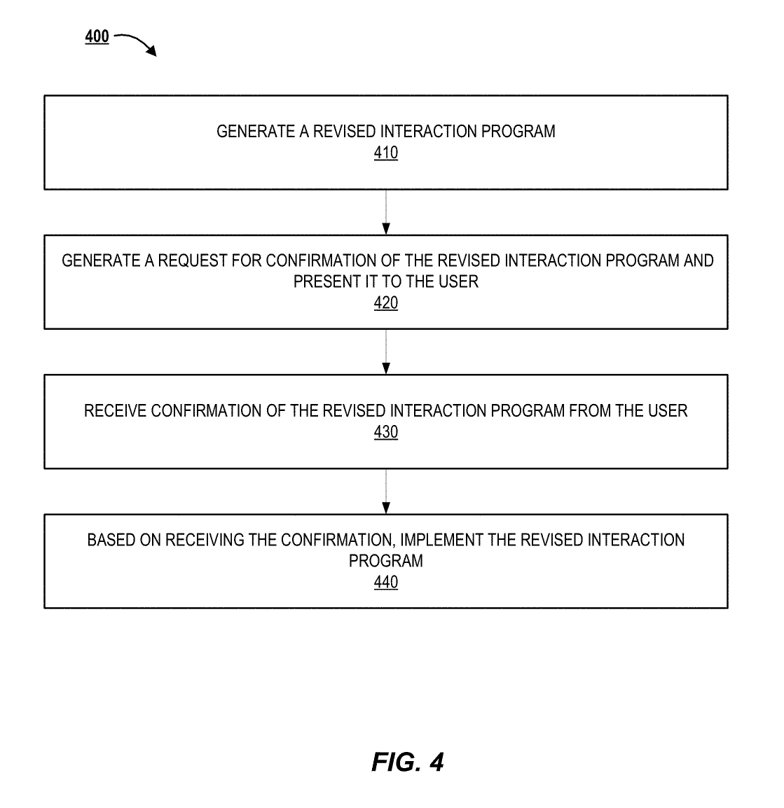

FIG. 4 illustrates a high level process flow for implementing a revised interaction program based on user confirmation 400, in accordance with one embodiment of the invention. As illustrated in block 410, the process 400 is initiated by the system first generating a revised interaction program according to a process similar to that of the process outline in FIG. 2. As illustrated in block 420 of FIG. 4, the system generates a request for confirmation of the revised interaction program and presents it to the user. In some embodiments, the system transmits the request in the form of a message within the interactive user application, a text message, an email, or a voice message. In some embodiments, the notification provides a detailed report of the revised interaction program including associated implemented interactions.

As illustrated in block 430 of FIG. 4, the system receives confirmation of the revised interaction report from the user. In some embodiments, the user responds to the request for confirmation via the user device, wherein the system receives the user's transmitted response.

As illustrated in block 440 of FIG. 4, based on receiving the confirmation of the revised interaction report from the user, the system implements the revised interaction program. In some embodiments, the system blocks implementation of the revised interaction program until approval is received from the user in response to the request for confirmation. In other embodiments, the revised interaction program is automatically confirmed unless the user responds with a denial to the request of confirmation. In some embodiments, receiving confirmation of the revised interaction program triggers the system to implement the program and associated interactions.

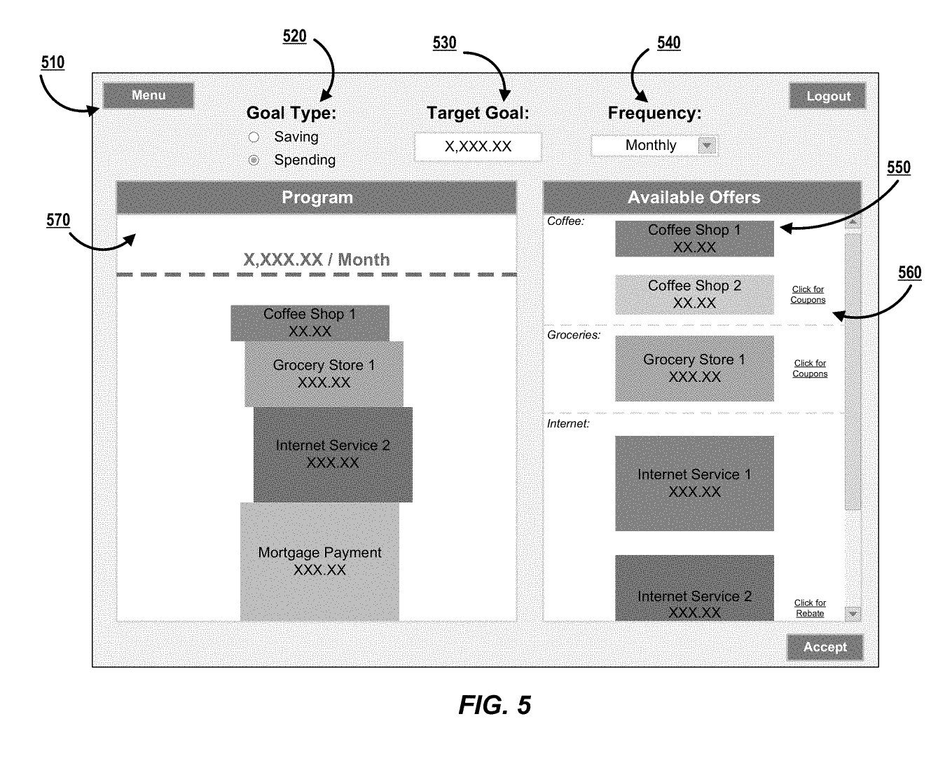

FIG. 5 provides a graphical representation of a portion of an interactive user application 500, in accordance with some embodiments of the invention. In some embodiments, the interactive user application provides a tool to the user for customizing financial planning based on the user's past transactions, resource storage target, and recommended interactions. In some embodiments of the invention, the interactive user application may allow the user and/or system to manipulate objects generated by the application to create a revised interaction program. In some embodiments, the application may be tailored for use on a computer, mobile phone, or other user devices as previously described. As illustrated in FIG. 5, in some embodiments, the application presents the user with means for navigating the interface by providing a menu button 510. In some embodiments the menu button may provide a drop-down menu which provides the user with additional interactive selections for navigation within the application such as navigating to other screens within the application, logging out of the application, viewing a user profile, and the like. In some embodiments the application provides a separate logout button which, when pressed, logs the user out of the application and returns the user to an initial log in screen where a user must provide authentication information to log in such as a password, code, biometric information, or the like to authorize access to the application.

In some embodiments, as illustrated in FIG. 5, the application provides the user with selectable goal type options 520 for the type of program that the user wishes the system to generate. In the embodiment presented in FIG. 5, the application allows for the generation of a saving type program, wherein the user stores and saves resources towards achieving a set resource storage target or goal, or a spending type program, wherein the user limits spending to a maximum budgeted amount set forth by the resource storage target. The application further provides a fillable field for user input of a target goal 530 such as a resource storage target. In some embodiments, the target goal may be determined by the system or a financial institution associated with the user. The application also provides a frequency selection 540 allowing the user to select a frequency or time limit of the goal. For example, the user may wish to set a goal that is daily, weekly, monthly, annual or the like. In some embodiments, the resource storage target is reset after the time limit expires, wherein a new resource storage target may be set by the user. In some embodiments, the user may set a resource storage target to be a recurring goal. For example, the user may wish to set a recurring spending budget for a set amount every month.

As illustrated by element 550 of FIG. 5, the application, in some embodiments, provides the user with available offers for creating an interaction program. In some embodiments, the application present the offers as one or more interactive tokens which may be in the form of text, an image, a line, a shape, a graph, a chart, a threshold, a puzzle, a progress bar, a fillable container, or any object which represents the value of the resource storage target and/or progress towards the resource storage target. The available offers may comprise past interactions associated with the user and recommended interactions generated by the system. In some embodiments, similar or comparable interactions may be categorized together to allow for comparison by the user. In some embodiments, a scrollable list of interactive tokens is provided by the application allowing the user to view and select one or more of the tokens for inclusion in a revised interaction program. For example, the application may provide one or more interactive tokens as blocks within a list of offers, wherein the user may interact with the blocks in order to create an interaction program. User interaction with the interactive tokens may comprise clicking, pressing, tapping, dragging, flicking, pinching, spreading, rotating, sliding, or any combination of actions via the user device. In some embodiments, the application may receive and process voice commands from the user for interacting with and selecting tokens. In some embodiments, and as illustrated by element 560 of FIG. 5, the application may further provide interactive links for coupons, rebates, discounts, deals, or the like associated with the one or more listed interactions. In some embodiments, the system and application integrate coupons, discounts, rebates, and the like into the prices of the presented interactions, so that the user may have a holistic view of the total value of the interactions.

As illustrated by element 570 of FIG. 5, the application provides a workspace for the manipulation of the interactive tokens for the creation of a revised interaction program. In some embodiments, the application comprise a game, a puzzle, or the like, wherein objects or tokens representing values generated by the application may be manipulated by the user and/or system in order to generate a savings program. The application may display the resource storage target or goal within the workspace in relation to the manipulated interactive tokens. In some embodiments, the application may display a total cost and/or savings of selected interactions or interactive tokens in relation to a resources storage target. In the embodiment of the application illustrated in FIG. 5, the interactive tokens are blocks representing the value of available interactions or offers. In this embodiment, the application is a game, where in the blocks must be precisely stacked by the user within the workspace to fit beneath a monthly spending limit.

In some embodiments of the invention one or more of the systems described herein may be combined with each other, or otherwise perform the functions of the other systems described herein. In other embodiments of the invention one or more of the applications described herein may be combined with each other, or otherwise perform the functions of the other applications described herein. Furthermore, the applications may be any type of application, such as an application stored on a desktop, server, or other device, a mobile application stored on a mobile device, a cloud application, or other like application. As such, the applications described herein, or portions of the applications described herein may be stored and operated on any of the systems or devices described herein. For example, a portion of one or more applications may be stored on the user device, or may be included as a portion of financial institution applications, such as an online banking application, in order to achieve embodiments of the inventions described herein.

It should be understood, that the systems and devices described in FIG. 1, or other devices not specifically described herein, may be configured to establish a communication link with each other in order to accomplish the steps of the processes described herein. The link may be an internal link within the same entity (e.g., within the same financial institution or device provider) or a link with the other systems of entities (e.g., social networking systems, third-party systems, or the like). In some embodiments, the systems may be configured for monitoring the applications and devices that the system(s) utilize as data sources. The information received from monitoring may be provided via wireless network path portions through the Internet. When the systems or devices are not monitoring a source or are not being monitoring, the information need not be transmitted from the source through the Internet to the destination, although it could be. The sources of information may be made continuously available, however, continuously available does not necessarily mean that the sources actually continuously generates data, but that a source is continuously available to generate and send data real-time (e.g., instantaneously and/or within a few seconds, or the like) of receiving a request for it. In any case, the sources may be continuously available to receive and/or generate information, in some cases in digitized data in Internet Protocol (IP) packet format. In response to continuously monitoring the real-time data feeds from the various systems or devices, the system may be configured to provide target information to the user and/or allow the user to make changes to or control the applications and/or devices.

Moreover, it should be understood that the process flows described herein include transforming the information sent and/or received from the applications of the different systems (e.g., internally or externally) and/or the devices from one or more data formats into a data format associated with an application for display to the user on the user device. There are many ways in which information is converted within the system environment. This may be seamless, as in the case of upgrading to a newer version of a computer program. Alternatively, the conversion may require processing by the use of a special conversion program, or it may involve a complex process of going through intermediary stages, or involving complex “exporting” and “importing” procedures, which may converting to and from a tab-delimited or comma-separated text file. In some cases, a program may recognize several data file formats at the data input stage and then is also capable of storing the output data in a number of different formats. Such a program may be used to convert a file format. If the source format or target format is not recognized, then at times a third program may be available which permits the conversion to an intermediate format, which can then be reformatted.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. patent | | |
|---|---|---|---|
| Docket Number | application Ser. No. | Title | Filed On |
| 7628US1.014033.2952 | To be assigned | TARGETED RESOURCE TOKEN | Concurrently |
| | | GENERATION AND DEPLOYMENT | herewith |
| 7629US1.014033.2953 | To be assigned | THIRD PARTY ACTIVITY | Concurrently |
| | | PERFORMANCE CROSS ENTITY | herewith |
| | | INTEGRATION | |
| 7630US1.014033.2954 | To be assigned | SYSTEM AND METHOD FOR | Concurrently |
| | | LOCATION-BASED | herewith |
| | | TRAFFICKING FOR RESOURCE | |
| | | ACCUMULATION | |
| 7632US1.014033.2956 | To be assigned | RESOURCE ALLOCATION | Concurrently |
| | | INTERFACE FOR INTERACTIVE | herewith |
| | | RESOURCE DISTRIBUTION | |

What is claimed is:

1. A system for interaction manipulation and implementation for resource storage, the system comprising:
at least one memory device with computer-readable program code stored thereon;
at least one communication device connected to a network;
at least one processing device operatively coupled to the at least one memory device and the at least one communication device, wherein the processing device is configured to execute the computer-readable program code to:
receive interaction information associated with a user, wherein the interaction information comprises past interactions and a resource storage target;
in response to receiving the past interactions, determine recommended interactions based on the past interactions;
generate an interactive user application, wherein the interactive user application is customized based on the interaction information and the recommended interactions;
install the interactive user application on a user device associated with the user;
generate interactive tokens based on the past interactions and the recommended interactions;
prompt the user to manipulate the interactive tokens thereby generating a revised interaction program; and
implement the revised interaction program.

2. The system of claim 1, wherein implementing the revised interaction program comprises automatically modifying user interactions.

3. The system of claim 2, wherein modifying the user interactions comprises canceling at least one past interaction.

4. The system of claim 2, wherein modifying the user interactions comprises enrolling the user in at least one recommended interaction.

5. The system of claim 1, wherein implementing the revised interaction program further comprises:
determining that the revised interaction program does not achieve the resource storage target; and
based on determining that the revised interaction program does not achieve the resource storage target, blocking implementation of the revised interaction program.

6. The system of claim 1, wherein implementing the revised interaction program further comprises:
generating and presenting a request for a confirmation of the revised interaction program to the user;
receiving the confirmation of the revised interaction program from the user; and
based on receiving the confirmation, implementing the revised interaction program.

7. The system of claim 1, wherein manipulating the interactive tokens further comprises making a selection of the interactive tokens for inclusion in the revised interaction program.

8. The system of claim 7, wherein a total value associated with the past interactions and the recommended interactions associated with selected interactive tokens achieves the resource storage target.

9. The system of claim 1, wherein the interactive tokens proportionally represent values of the past interactions and the recommended interactions associated with the interactive tokens.

10. The system of claim 1, wherein the past interactions comprise transactions and subscriptions associated with the user.

11. The system of claim 1, wherein the recommended interactions comprise transactions and subscriptions not associated with the user.

12. A computer program product for interaction manipulation and implementation for resource storage, the computer program product comprising at least one non-transitory computer readable medium having computer-readable program code portions embodied therein, the computer-readable program code portions comprising:
an executable portion configured for receiving interaction information associated with a user, wherein the interaction information comprises past interactions and a resource storage target;
an executable portion configured for, in response to receiving the past interactions, determining recommended interactions based on the past interactions;
an executable portion configured for generating an interactive user application, wherein the interactive user application is customized based on the interaction information and the recommended interactions;
an executable portion configured for installing the interactive user application on a user device associated with the user;
an executable portion configured for generating interactive tokens based on the past interactions and the recommended interactions;
an executable portion configured for prompting the user to manipulate the interactive tokens thereby generating a revised interaction program; and
an executable portion configured for implementing the revised interaction program.

13. The computer program product of claim 12, wherein implementing the revised interaction program comprises automatically modifying user interactions.

14. The computer program product of claim 13, wherein modifying the user interactions comprises canceling at least one past interaction.

15. The computer program product of claim 13, wherein modifying the user interactions comprises enrolling the user in at least one recommended interaction.

16. The computer program product of claim 12, wherein implementing the revised interaction program further comprises:
determining that the revised interaction program does not achieve the resource storage target; and
based on determining that the revised interaction program does not achieve the resource storage target, blocking implementation of the revised interaction program.

17. The computer program product of claim 12, wherein implementing the revised interaction program further comprises:
generating and presenting a request for a confirmation of the revised interaction program to the user;
receiving the confirmation of the revised interaction program from the user; and
based on receiving the confirmation, implementing the revised interaction program.

18. The computer program product of claim 12, wherein manipulating the interactive tokens further comprises making a selection of the interactive tokens for inclusion in the revised interaction program.

19. A computer-implemented method for interaction manipulation and implementation for resource storage, the method comprising:
receiving interaction information associated with a user, wherein the interaction information comprises past interactions and a resource storage target;
in response to receiving the past interactions, determining recommended interactions based on the past interactions;
generating an interactive user application, wherein the interactive user application is customized based on the interaction information and the recommended interactions;
installing the interactive user application on a user device associated with the user;
generating interactive tokens based on the past interactions and the recommended interactions;
prompting the user to manipulate the interactive tokens thereby generating a revised interaction program; and
implementing the revised interaction program.

20. the computer-implemented method of claim 19, wherein implementing the revised interaction program comprises automatically modifying user interactions.
